(19) United States
(12) Patent Application Publication
(10) Pub. No.: US 2006/0075183 A1
(43) Pub. Date: Apr. 6, 2006

(54) [METHOD OF APPLYING FLASH MEMORY AS BUFFER IN ELECTRICAL APPLIANCE]

(75) Inventors: Chien-Yu Lin, TAIPEI (TW); Hon-Wai Ng, TAIPEI (TW)

Correspondence Address: PHISON ELECTRONICS CORPORATION, 2F-4. NO. 148, SEC. 4, CHUNG HSIAO EAST ROAD, TAIPEI, TW

(73) Assignee: PHISON ELECTRONICS CORP., HSINCHU HSIEN. (TW)

(21) Appl. No.: 10/711,799

(22) Filed: Oct. 6, 2004

(51) Int. Cl. G06F 12/00

(52) U.S. Cl. 711/103; 711/165

(57) ABSTRACT

According to an aspect of the present invention, the expensive RAM is replaced by a low cost flash memory, wherein a space in the flash memory is defined to serve as a buffer of an electrical appliance. Thus, the cost of the electrical appliance can be effectively reduced. Furthermore, output/input terminal for connecting RAM to the microprocessor can also be avoided, which would further reduce the cost of the electrical appliance.

### BACKGROUND OF THE INVENTION

1. Field of the Invention

The present invention relates to a method of applying a flash memory as a buffer in an electronic appliance, and more particularly to a method of applying a flash memory in which a space in the flash memory is defined to serve as a buffer for storing data or program in an electronic appliance. Thus, the expensive RAM can be replaced by the low cost flash memory.

2. Description of Related Art

Rapid advancement of electronic technology has led to development of a variety of electronic appliances in our everyday life, for example, computer, cellular phone, digital camera and so on. All of these electronic appliances are multi-functional and more and more functions are being added to new generation electronic products. Furthermore, peripheral products are also externally connected to the electronic appliances to add more functions. Nowadays, both computers and peripheral products are consistently improved for enhancing their capabilities. Correspondingly, the software also needs to be updated from time to time. Furthermore, it is also important reduce the cost in order to make computers and peripheral products attractive and user friendly. The need of computers is constantly growing; accordingly the computer market is also growing which is of great interest to the manufacturers.

Generally, the processing speed of the microprocessor of the electronic appliance is far more faster than the output device, for example, printer, monitor and the like, the microprocessor has to wait until the output device has completed the data processing and thus the efficiency thereof is reduced. Therefore, RAM is applied to serve as a buffer of many electronic appliances that allow the microprocessor to temporarily store data or command, and the RAM transmits data or command to the output device to aid the microprocessor. However, RAM is expensive and therefore the cost of the electrical appliances including RAM would be quite expensive as well. Thus, such electrical appliances including RAM are not attractive on the market. Besides, RAM has limited memory space to support the microprocessor and the data processing will slow down when the content of the data or program to be processed is large. Therefore, the efficiency of the microprocessor can be affected when the data or program to be processed is large despite application of RAM.

Flash memory is popular because of its advantages of low power consumption, non-volatility, shock proof, high storage density and the like has gradually replaced EEPROM or memories operated by battery power. In addition, the development of semiconductor technology has made it possible to further increase the storage density and transmission speed of flash memory. Thus, the flash memory has successfully replaced the traditional storage media such as hard disk. Because of the advantageous functions and features of the flash memory, more and more manufacturers started to develop storage media using flash memory such as portable ROM and memory card. Ever since, such storage media are available on the market and the users have realized the convenience and advantages flash memory. Therefore, flash memory has become indispensable. The cost of flash memory is much lower compared to that of RAM. It should be noted that flash memory can be used as buffer for larger memory and if flash memory can be applied to function as RAM, it is possible for flash memory to successfully replace RAM. Therefore, it is possible to reduce the cost of the electronic appliance and attract the interest of users.

Therefore, application of flash memory to serve as buffer in the electronic appliance is of great interest to the manufacturers in the field.

### SUMMARY OF THE INVENTION

Accordingly, in the view of the foregoing, the present inventor makes a detailed study of related art to evaluate and consider, and uses years of accumulated experience in this field, and through several experiments, to create a new method of applying a flash memory in an electronic appliance to replace the expensive RAM. The present invention provides an innovated cost effective method of applying a low cost flash memory in an electrical appliance, wherein a space in the flash memory is defined to serve as a buffer for storing data or program in an electronic appliance. Thus, the overall cost of the electrical appliance can be effectively reduced.

According to an aspect of the present invention, a low cost flash memory is applied in an electronic appliance to function as a buffer instead of RAM, wherein a space in the flash memory is defined to serve as a buffer of an electrical appliance. Thus, the cost of the electrical appliance can be effectively reduced. Furthermore, output/input terminal for connecting RAM to the microprocessor can also be avoided, which would further reduce the cost of the electrical appliance.

### BRIEF DESCRIPTION OF THE DRAWINGS

For a more complete understanding of the present invention, reference will now be made to the following detailed description of preferred embodiments taken in conjunction with the following accompanying drawings.

FIG. 1 is a flowchart illustrating a method of applying flash memory as buffer in an electronic appliance according to an embodiment of the present invention.

FIG. 2 is a block diagram illustrating an operation procedure flash memory serving as a buffer of an electronic appliance according to an embodiment of the present invention.

### DETAILED DESCRIPTION OF EMBODIMENTS

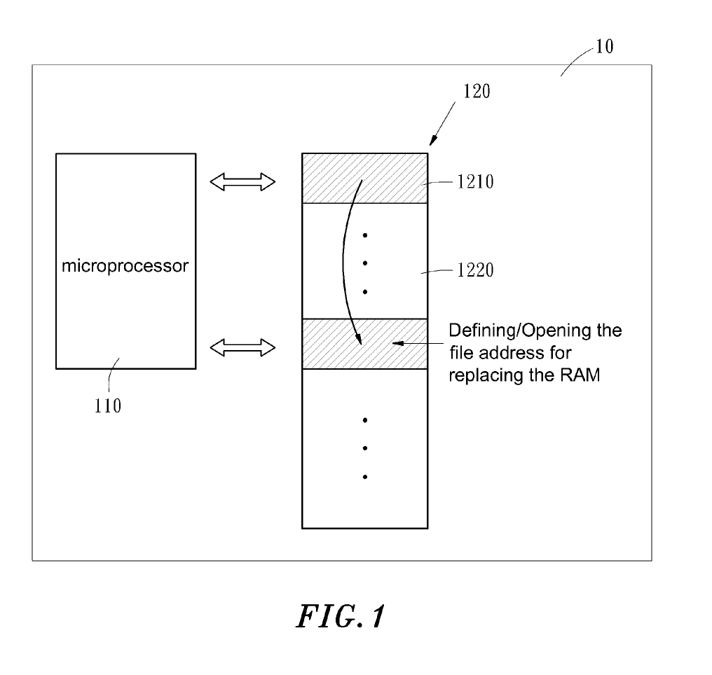

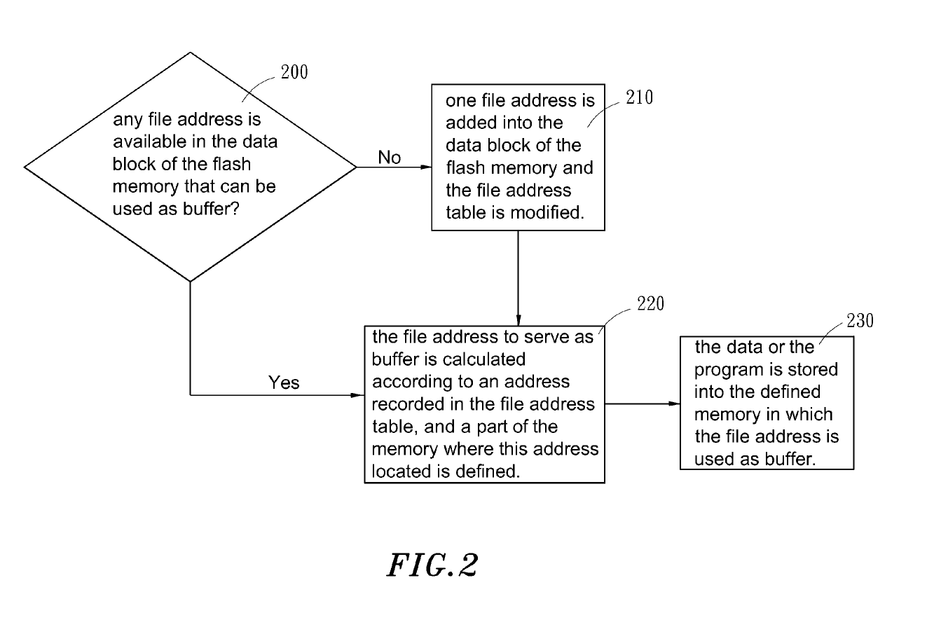

Referring to FIGS. 1 and 2, the electronic appliance 10, according to an embodiment of the present invention, comprises a microprocessor 110 and a flash memory 120.

The microprocessor 110 is adapted for receiving or executing commands from a user.

The flash memory 120 is connected to the microprocessor 110. The flash memory 120 comprises a file address table 1210 of a recordable file address and a data block 1220 for storing data or program.

When the microprocessor 110 commands the flash memory 120 to store data or program, the flash memory 120 operates as follows for storing data or program:
at step 200, whether any file address is available in the data block 1220 of the flash memory 120 that can be used as buffer is checked, wherein if any file address is available, the procedure proceeds to step 220, otherwise, the procedure proceeds to step 210;
at step 210, one file address is added into the data block 1220 of the flash memory 120 and the file address table 1210 is modified, and the procedure proceed step 220;
at step 220, the file address for serving as buffer is calculated according to an address recorded in the file address table 1210, and a part of the memory block where this address located is defined; and
at step 230, the data or the program is stored into the defined memory in which the file address is used as buffer.

Therefore, a space of the lower cost flash memory 120 can be defined to serve as buffer and thus the use of expensive RAM can be avoided. Furthermore, the use of expensive input/output terminal for connecting an external RAM to the microprocessor 110 can also be avoided. Thus, the overall cost of the electronic appliance 10 can be effectively reduced.

Furthermore, the electronic appliance 10 of the present invention can be display card, sound card, media device of the flash memory 120 can be, such as, audio/video player, MP3 player, memory card, portable ROM and the like.

According to an aspect of the present invention, the flash memory 120 can be used as a buffer of an electronic appliance 10, wherein a space of the data block 1220 of the flash memory 120 can be defined to serve as buffer and the address of the defined space recorded in the file address chart 1210 is adapted for storing the data or the program therein. Thus, the microprocessor 110 can effectively and efficiently function without the expensive RAM. In other words, both the expensive RAM and the input/output terminal for connecting the RAM to the microprocessor 110 can be avoided. Thus, the overall cost can be effectively reduced.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What is claimed is:

1. A method of applying a flash memory as a buffer in an electronic appliance, comprising:
installing a microprocessor in the electronic appliance, wherein said microprocessor receives or executes commands of a user;
installing a flash memory in the electronic appliance, wherein said flash memory is connected to said microprocessor and comprises a file address table of a recordable file address and a data block for storing data or program, and wherein when the microprocessor commands the flash memory to store data or program, the flash memory operates to store said data or program as follows:
(A) checking whether any file address is available for serving as buffer in said data block of said flash memory, wherein if a file address in said data block is available to serve as buffer, the operation procedure proceeds to step (C);
(C) calculating the file address serving as buffer according to an address recorded in the file address table, and defining a memory block where this address is located; and
(D) storing said data or program in said defined memory block whose file address is used as buffer.

2. The method of applying a flash memory as buffer in an electronic appliance according to claim 1, wherein if no file address in said data block is available to serve as buffer, the operation procedure proceeds to step (B), wherein one file address is added into the data block of the flash memory and the file address table is modified and the operation procedure continue to step (C).

3. The method of applying a flash memory as buffer in an electronic appliance according to claim 1, wherein said electronic appliance comprises a display card.

4. The method of applying a flash memory as buffer in an electronic appliance according to claim 1, wherein said electronic appliance comprises a sound card.

5. The method of applying a flash memory as buffer in an electronic appliance according to claim 1, wherein said flash memory comprises a memory card.

6. The method of applying a flash memory as buffer in an electronic appliance according to claim 1, wherein said flash memory comprises a portable ROM.
